(19) United States
(12) Patent Application Publication
(10) Pub. No.: US 2023/0173846 A1
(43) Pub. Date: Jun. 8, 2023

(54) NON-PNEUMATIC TIRE

(71) Applicants: Brooks ADAMS, Greenville,, SC (US); Christopher Mast, Greenville, SC (US); Patrick F. KING, Greenville, SC (US); Compagnie Generale des Etablissements Michelin, Clermont-Ferrand (FR)

(72) Inventors: Brooks ADAMS, Greenville, SC (US); Christopher MAST, Greenville, SC (US); Patrick F. KING, Greenville, SC (US)

(21) Appl. No.: 17/997,552

(22) PCT Filed: Apr. 30, 2021
(86) PCT No.: PCT/US2021/030231

§ 371 Date: Oct. 30, 2022

Related U.S. Application Data
(60) Provisional application No. 63/018,502, filed on Apr. 30, 2020.

(51) Int. Cl. B60C 7/10; B60C 7/14

(52) U.S. Cl. CPC B60C 7/102; B60C 7/146; B60C 2200/14

(57) ABSTRACT

A non-pneumatic tire (100) having an annular beam (200) and an annular support (103) comprising a plurality of thermoplastic elastomeric spokes formed by a thermoplastic injection process. When manufacturing this non-pneumatic tire via a mold, then the radial extent of a mold cavity is defined by the radially inner extent of the annular beam (200). The non-pneumatic tire's annular beam (200) includes a first elastomer and a circumferential reinforcement extended in a circumferential direction. The annular beam (200) is free of the circumferential reinforcement at an axial extent over a width of at least 8 mm the axial extent comprising the first elastomer. The plurality of thermoplastic elastomeric spokes are made of a second elastomer and extend radially inward from the annular beam (200). The present invention also refers to a process for forming such a non-pneumatic tire (100).

This is a application claims the benefit of U.S. Application No. 63/018,502, filed Apr. 30, 2020.

### FIELD OF THE INVENTION

This disclosure relates to non-pneumatic tires (NPTs) for on-road or off-road vehicles (e.g., automobiles, light trucks, and heavy trucks, all-terrain vehicles, zero turn radius lawn mowers, military vehicles). Particularly, it relates to off-road vehicles which may require higher speed and load capabilities, along with high damage tolerance.

### BACKGROUND OF THE INVENTION

Non-pneumatic tires (NPTs) have advantages over pneumatic tires. NPTs are not pressure vessels, as are pneumatic tires. They cannot fail due to air pressure loss.

Cord-rubber composite construction has advantages for NPT performances. Such composite construction may provide high stiffness in a preferred direction, while enabling bending in a preferred direction. Of course, A rubber tread is very efficient in developing traction forces while providing long wear life. For these reasons, a reinforced annular beam may offer high performance. Further, a rubber tread placed on the outer radial extent of the annular beam may also be a preferred design.

A tension-based NPT may provide efficient load carrying mechanisms. For such NPTs, a radially inner surface of the annular beam may be supported by an annular support which develops tensile forces. The annular support may comprise a plurality of radially oriented spokes. Since they work in tension, an efficient spoke should comprise a high modulus material. Isotropic rubber is not high modulus. Placing cord reinforcement in the spokes may be tedious or costly. For this reason, other materials, such as thermoplastic elastomers or cast polyurethane elastomers may be a viable choice.

U.S. Pat. No. 9,751,270 (owned by current applicant) discloses a thermoplastic molding procedure for forming the spokes of an NPT. Thermoplastic injection is a mature industry, which may provide low cost for the NPT. However, there is no disclosure in this prior art pertaining to a process for forming an NPT that comprises a thermoplastic annular support with an annular beam comprising a cord-rubber composite.

The current disclosure provides a process for forming an NPT with a cord-rubber annular beam and a thermoplastic annular support. The annular beam is formed in an initial molding operation, then placed in a thermoplastic injection mold. The axial extents of the annular beam are designed to create a dynamic seal. When placed in the mold, the pressure of the injected elastomer causes a specific deformation at the axial extents of the beam. Further, the mold profile which engages the beam axial extents is defined such that a highest contact pressure is created at the radially inward extent. This creates a dynamic shut-off effect, allowing excellent molding control in a critical area.

### SUMMARY OF THE INVENTION

Aspects and advantages of the invention will be set forth in part in the following description, or may be obvious from the description, or may be learned through practice of the invention.

The invention has general application for vehicles that use tires. Specifically, application is especially suited to off-road vehicles that may require high speed and high load, as well as high absorbed energy capabilities.

According to an aspect of the invention, there is provided a non-pneumatic tire comprising an annular beam, an annular support extending radially inward from the annular beam, said support comprising a thermoplastic elastomer. The annular beam has a portion which has a circumferential reinforcement. This portion extends in the axial direction. The annular beam has a portion which has no circumferential reinforcement. There is one portion on a lateral extent of the annular beam, and a second portion on a second lateral extent. These portions each extend at least 8 mm in the axial direction of the annular beam.

According to an aspect of the invention, there is provided a process for forming a non-pneumatic tire, the non-pneumatic tire comprising an annular beam and an annular support. The annular beam is formed in a first process. The annular beam is placed in a thermoplastic injection mold. A second forming process comprises thermoplastic injection, during which an annular support is formed and affixed to a radially inward surface of the annular beam. The annular beam and the mold are configured such that an axial extent of the annular beam functions as a deformable gasket. During the molding process, a contact pressure is created between the mold and a radially inward portion of the lateral extents of the beam. This pressure provides shut-off and obstructs a flow of elastomer between the axial extents of the beam and the mold. A mold profile of the thermoplastic mold may comprise a convex segment that creates the shut-off pressure.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A detailed description of embodiments is provided below, by way of example only, with reference to the accompanying drawings, in which:

FIG. 1 is an exemplary example of an NPT.

FIG. 2 is an exemplary example of an annular beam, the annular beam comprising a tread.

FIG. 3 is a R-Y cross section view of an annular beam and tread pattern

FIG. 4 is an R-Y cross section view of an annular beam with tread pattern placed in a mold for thermoplastic injection.

FIG. 5 is an undeformed geometry of an annular beam and tread for an FEA simulation of an injection molding process.

FIG. 6 is a close-up of an axial extent of FIG. 5.

FIG. 7 is a deformed geometry of an annular beam and tread for an FEA simulation of a thermoplastic molding process, after a mold has been closed.

FIG. 8 is a close-up of an axial extent of FIG. 7.

FIG. 9 is a deformed geometry of an annular beam and tread for an FEA simulation of a thermoplastic molding process, after a mold has been closed and a thermoplastic material for forming an annular support has been injected.

FIG. 10 is a close-up of an axial extent of FIG. 9.

The use of identical or similar reference numerals in different figures denotes identical or similar features. It is to be expressly understood that the description and drawings are only for purposes of illustrating certain embodiments and are an aid for understanding. They are not intended to and should not be limiting.

### DEFINITION OF TERMS

The following terms are defined as follows for this disclosure, with material properties referring to those at ambient temperature, unless otherwise noted:

“Hub” refers to any structure for supporting the tire and capable of attachment to a vehicle axis.

When referring to a thermoplastic elastomer, “modulus” means Young's tensile modulus of elasticity measured per ISO 527-1:2019.

When referring to a reinforcement cord or cable, “modulus” means Young's tensile modulus of elasticity measured per ASTM D2969. The tensile modulus may be calculated as the secant modulus at a strain of 0.5%.

When referring to rubber, “shear modulus” refers to the dynamic shear modulus as measured according to ASTM D5992-96 (2018), at 10 HZ, 23C, and 2% strain. When referring to rubber, “extension modulus” refers to a Young's modulus measured according to ASTM D412.

### DETAILED DESCRIPTION OF THE INVENTION

The present invention provides a non-pneumatic tire, a mold for making such non-pneumatic tire and process for forming such a non-pneumatic tire. For purposes of describing the invention, reference now will be made in detail to embodiments and/or methods of the invention, one or more examples of which are illustrated in or with the drawings. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

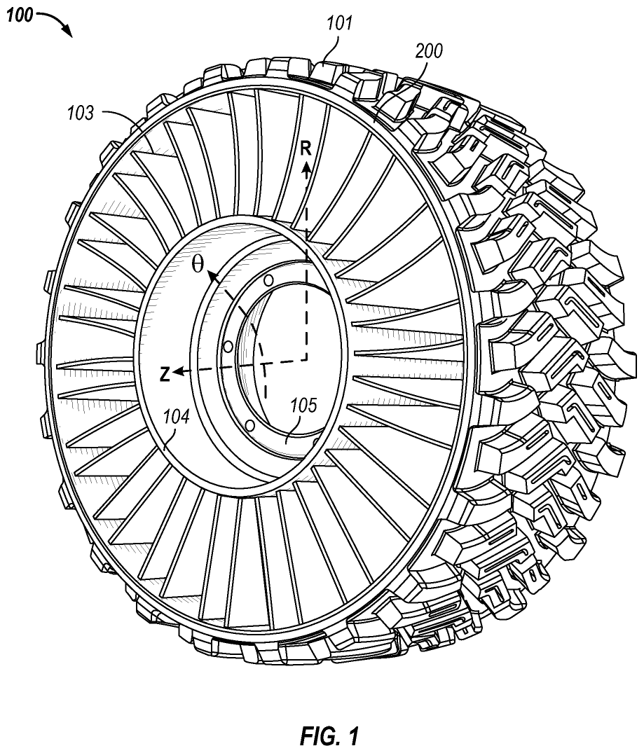

FIG. 1 shows an exemplary example of an NPT 100, in the size 26×10-12. This is a common size for off-road applications. The tire defines a cylindrical coordinate system with radial direction R, circumferential direction □, and axial direction Y. A convenient cartesian coordinate system has X as the direction of travel of the tire, Y as the axial direction, and Z as the vertical direction.

The tire comprises an annular beam 200 that comprises a tread portion 101. The beam comprises reinforcement in the circumferential direction. The tire further comprises an annular support portion 103 which comprises a thermoplastic elastomer, a rim portion 104, and a hub portion 105. In this embodiment, the annular support portion comprises spokes that extend in the radial direction, connecting the inner surface of the annular beam to the rim without intersection with any ones of the other spokes.

In this embodiment, the annular beam is formed in an initial molding operation. Along with the hub portion 105, the annular beam is placed in a mold for a secondary molding operation, in which the spokes are formed using thermoplastic injection.

Prior art construction, such as that described in U.S. Pat. No. 9,004,901, used thermoset polyurethane to form the spokes. The current application discloses a method of forming the spokes with thermoplastic injection of thermoplastic elastomer. An exemplary process provides for an efficient shut-off at the lateral extents of the annular beam, preventing injected elastomer from flowing between a mold and the beam.

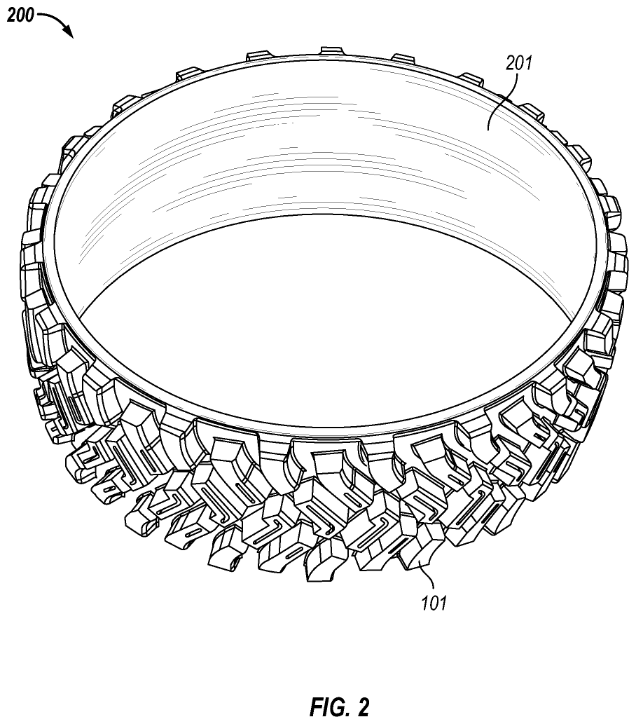

FIG. 2 shows an exemplary annular beam 200, comprising a tread pattern 101. The annular beam has an inner radial extent 201. The annular beam is formed in a first operation, then inserted into a thermoplastic injection mold for a second forming operation. In an exemplary example, a hub 105 may also be placed in the mold. An annular support 103 is formed in the injection process. In an exemplary example, a rim 104 may also be formed in the same injection process, Thus, the injection process may form the spokes and rim, and further connect the beam, spokes, rim, and hub, thereby forming the exemplary NPT 100 of FIG. 1.

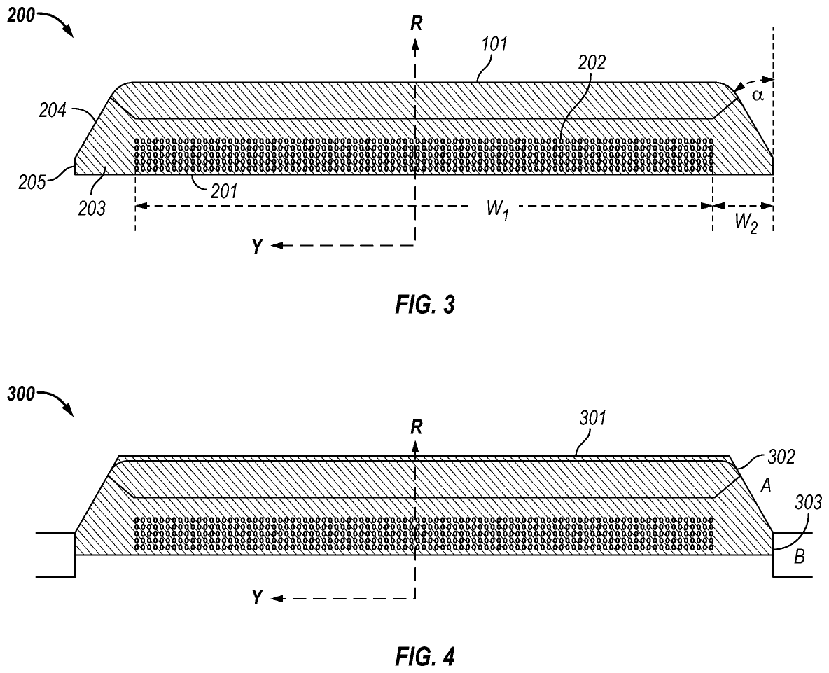

FIG. 3 shows an R-Y cross section of an annular beam 200. The beam comprises a reinforcement portion 202, extending in the axial direction over a width W₁. The reinforcement provides stiffness primarily in the circumferential direction. At the lateral extent of the beam, portion 203 has no reinforcement. In an exemplary NPT, portion 203 may comprise isotropic rubber and be free of a tread pattern; i.e., it may be a solid of revolution. Portion 203 has a width W₂. For an efficient process of forming the annular support, the inventors have found that W₂ should be at least 8 mm in width; in other cases, at least 12 mm in other cases, at least 16 mm, and in other cases, even wider.

The annular beam has a profile at the lateral extents which may be defined by portion 204 and portion 205. In an exemplary example 204 may be generally linear and may be inclined from the radial direction by an angle □. For an efficient process of forming the annular support, the inventors have found that □ should be at least 15 degrees; in other cases, at least 30 degrees, and in other cases, at least 45 degrees.

Because the annular beam does not comprise circumferential reinforcement near the lateral extents, the beam will have much greater compliance at the axial extents. The inventors have found that this compliance can be controlled by the choice of W₂ and □. A wider W₂ and a larger □ may create a more compliant portion 203. The inventors have discovered how to use these design features in concert with a design of a thermoplastic mold. Surprisingly, the compliance of the axial extents may be used to form a dynamic gasket which deforms under a pressure of thermoplastic injection and creates a desired contact pressure against the mold. Once deformed, portion 203 provides a seal that obstructs a flow of thermoplastic material between the mold and the axial extents of the annular beam.

FIG. 4 shows an R-Y cross section of an annular beam, placed into a mold for thermoplastic injection. A mold profile 301 contacts an outer radial extent of the annular beam. Profile 302 contacts an outer radial extent of an axial extent of the annular beam. Profile 303 contacts an inner radial extent of an axial extent of the annular beam.

The mold may be configured in any suitable way. An exemplary mold configuration has a radially actuated mold part A which comprises profiles 301 and 302. Part A may comprise sectors. Those skilled in the art of tire design will be familiar with a sector mold design. A mold part B may comprise profile 303. An exemplary mold configuration has an axially actuated mold part B.

An exemplary thermoplastic molding process for forming the annular support may comprise these process steps:
Mold profiles 301 and 302 of mold portion A are radially retracted.
Mold profile 303 of mold portion B is axially retracted.
The annular beam is placed in the mold.
Mold portion A radially extends, contacting the outer radial extent of the beam.
Mold portion B axially extends, contacting the axial extent of the beam.
The mold is closed, creating a molding cavity into which a thermoplastic elastomer can be injected to form the annular support.
The outer radial extent of the molding cavity comprises the inner radial extent 201 of the annular beam. The annular beam, therefore, defines a surface of the mold cavity.
The thermoplastic elastomer is injected into the mold cavity.
A molding pressure creates a deformation of the annular beam portion 203.
This deformation creates a contact pressure on mold profile 303.
This contact pressure creates a shut-off, impeding the flow of elastomer between the annular beam and the mold.
The annular support 103 is formed.
The mold opens, which comprises axial retraction of profile 303 and radial retraction of profile
The exemplary NPT is removed from the mold.

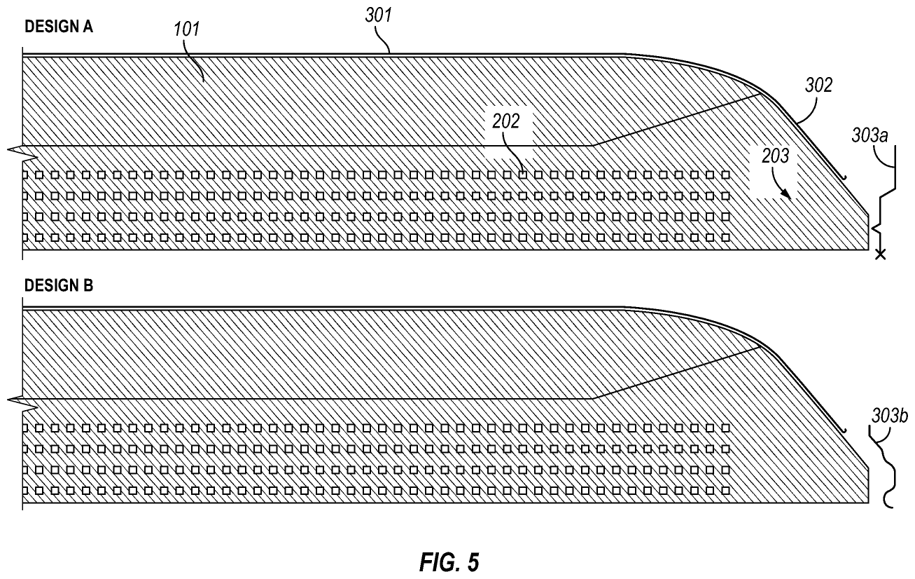

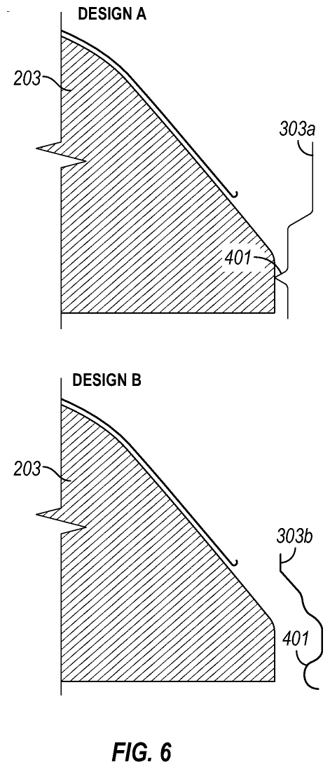

The inventors have reduced this process to practice using an exemplary annular beam. Further two different versions of mold profile 303 were designed and reduced to practice. FIGS. 5 through 10 illustrate several of the above steps using 2D axisymmetric finite element modeling (FEA). The two different profiles were analyzed and compared to empirical observations.

FIG. 5 shows an FEA model of an exemplary annular beam R-Y cross section placed in a mold. Design A is a first design for mold profile 303a. Design B is a second design for mold profile 303b. Design B is an exemplary design, which will be explained below.

For both Design A and Design B, the figure shows mold profiles 301 and 302 radially extended and contacting the annular beam. Mold profile 303 is adjacent to but not contacting the annular beam. The annular beam has reinforcements 202, a tread pattern portion 101, and a portion 203 at the axial extent that is isotropic rubber.

FIG. 6 is a close-up of the axial extents of the annular beam and profiles 303a and 303b. Profile 303a has a section 401. This pointed section is designed to create a high pressure on the annular beam lateral extent, when the mold is closed. Profile 303b has a section 501. This convex rounded section is designed to create a high pressure on the inner radial extent of the lateral extent of the annular beam. Further, profile 303b enables the portion 203 to deform and efficiently create a shut off over a large area of profile 303b, as shown below.

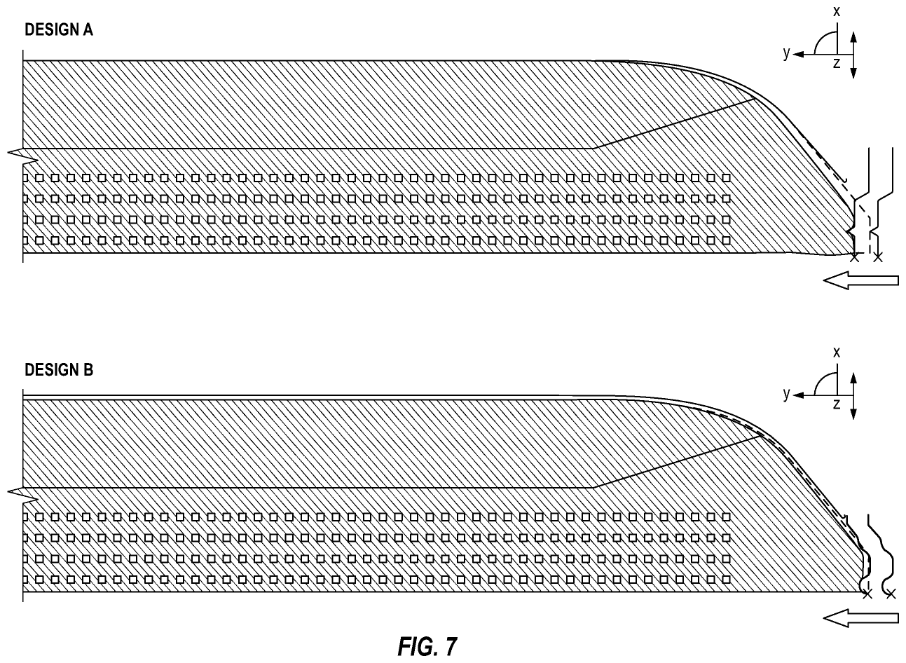

FIG. 7 shows Design A and Design B after profiles 303a and 303b are closed, respectively. At this step, no thermoplastic injection has occurred. The mold is simply closed and in contact with the outer radial and axial extents of the annular beam.

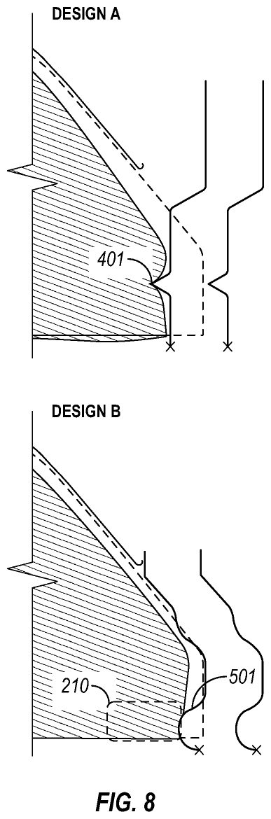

FIG. 8 is a close-up of the axial extents of FIG. 7. Profile 303a has created a high local pressure due to section 401. 303b has created a lower pressure, but over a larger surface area. Region 210 in Design B is a critical area because it is located at a most desirable region for creating a shut off function, inhibiting injected elastomer from flowing between the mold and the annular beam.

In at least one embodiment, the shut-off pressure is from a combination of the deformation caused by the interference with the radially inward convex feature, and also by the pressure from the injection of the material during the molding process. As this pressure increases, the unreinforced rubber is forced to conform into the relief between the radially inner and outer convex features, which results in the strong shut-off that can resist blow-by from the resin molding process.

The laterally outward deformation of the axially outer portion of annular beam allows the radially inner surface to deform radially outward in the unreinforced region near the axial extent. After the injection process, while the thermoplastic is cooling and shrinking, as the NPT is demolded, the deformation caused by the sealing process is relieved, so that the radially inner surface moves back radially inward, in the same direction that the bonded thermoplastic is pulling. So, instead of those components creating tension against one another along the edge of the annular beam between the thermoplastic and the rubber, they instead create compression forces, which helps to alleviate the tension on the bond between the thermoplastic and the rubber, resulting in an improved bond.

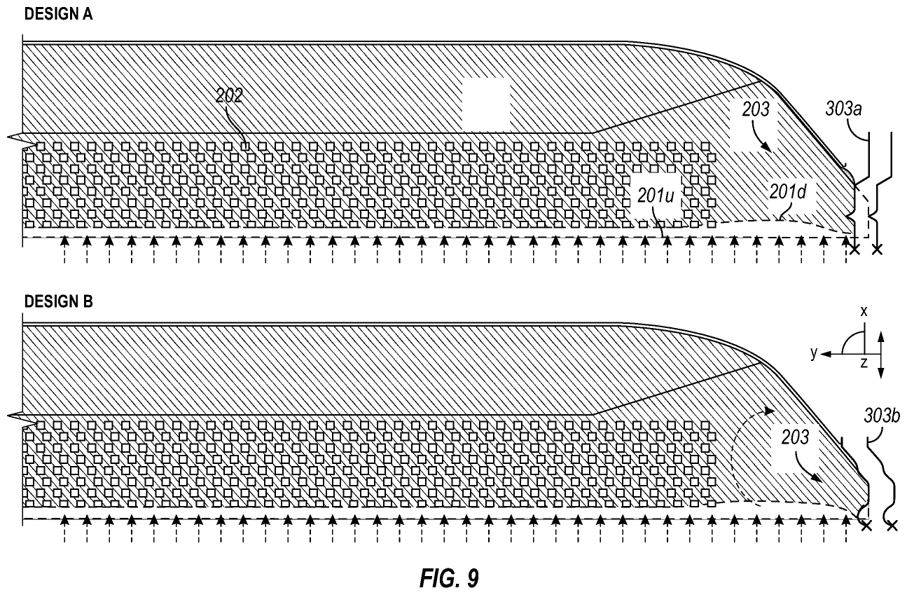

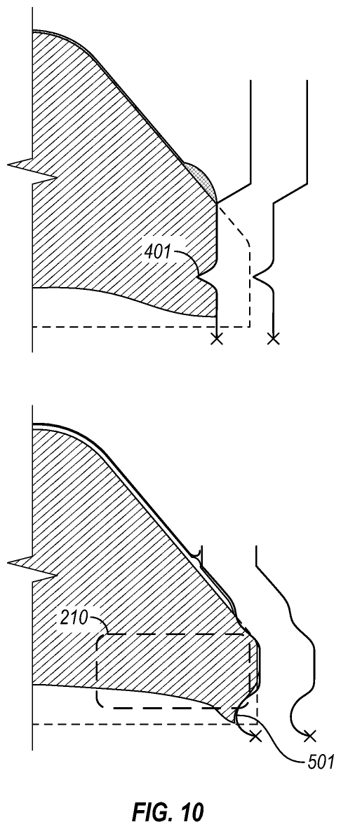

FIG. 9 shows a deformed geometry after a thermoplastic injection process has created a pressure on the inner radial surface of the annular beam. 201u is the “undeformed” profile and 201d is the “deformed” profile, under a pressure of 3.5 MPa (500 psi). For both designs, the deformed profile 201d is close to and parallel to 201u in the region that is radially inward from the reinforcement 202. Then, radially inward from region 203 the deformation is larger. This is because of the lack of reinforcement in region 203. Rather surprisingly, the inventors have found that this behavior may create a dynamic seal or gasket effect.

Related to this is the deformation of Design B. The portion 203 of isotropic rubber surprisingly has deformed and rotated into profile 303b, creating a large contact area and contact pressure.

FIG. 10 shows a close-up of the lateral extents of FIG. 9. Design A does create a locally high contact pressure due to profile 401. This can serve to create a shut-off function. However, Design B allows a large region of contact between the tire and the mold, and does not risk damaging the rubber due to locally high pressures. Due to lack of reinforcement, the entire region 203 deflects radially outward under injection pressure. Then, thanks to profile 303b—and especially the convex profile portion 501, a relatively large region 210 of rubber is firmly compressed against the mold profile. This creates an efficient shut off without risk of damage to the annular beam.

As mentioned earlier, designs A and B were reduced to practice, and tires were fabricated using both mold profiles 303a and 303b. While both designs did provide shut off, the profile 303b was superior. Tires manufactured with 303b had very clean molding characteristics and high quality, thanks to the combination of the mold profile 303b and the design of the annular beam in the region near the axial extents. The design of the mold worked together with the design of the annular beam to create an exemplary molding process.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Any feature of any embodiment discussed herein may be combined with any feature of any other embodiment discussed herein in some examples of implementation.

Although various embodiments and examples have been presented, this was for purposes of description, but not should not be limiting. Various modifications and enhancements will become apparent to those of ordinary skill in the art.

As used herein, the term “method” or “process” refers to one or more steps that may be performed in other ordering than shown without departing from the scope of the presently disclosed invention.

The terms “a,” “an,” and the singular forms of words shall be taken to include the plural form of the same words, such that the terms mean that one or more of something is provided. The terms “at least one” and “one or more” are used interchangeably. Ranges that are described as being “between a and b” are inclusive of the values for “a” and “b.”

Every document cited herein, including any cross-referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

We claim:

1. A non-pneumatic tire comprising:
an annular beam comprising a first elastomer, a circumferential reinforcement extended in a circumferential direction, the annular beam being free of the circumferential reinforcement at an axial extent over a width of at least 8 mm, the axial extent comprising said first elastomer;
an annular support extending radially inward from the annular beam, said support comprising a second elastomer; said support being formed by a thermoplastic injection process in which an outer radial extent of a mold cavity is defined by an inner radial extent of the annular beam.

2. The non-pneumatic tire of claim 1 wherein the annular beam is free of the circumferential reinforcement at an axial extent over a width of at least 12 mm.

3. The non-pneumatic tire of claim 2 wherein the annular beam is free of the circumferential reinforcement at an axial extent over a width of at least 8 mm.

4. The non-pneumatic tire of claim 3 wherein the first elastomer comprises a rubber.

5. The non-pneumatic tire of claim 4 wherein the second elastomer is a thermoplastic.

6. The non-pneumatic tire of claim 5 wherein the second elastomer is a polyurethane.

7. A process for forming an non-pneumatic tire, the process comprising
forming an annular beam, the annular beam comprising a first elastomer, the annular beam further comprising a reinforcement extended in a circumferential direction; the annular beam being free of the circumferential reinforcement at an axial extent over a width of at least 8 mm, the axial extent comprising said elastomer;
molding an annular support affixed to an inner radial extent of the annular beam by a thermoplastic injection process that uses a mold, the mold contacting and sealing against an outer radial extent of the annular beam; and
removing the NPT from the mold.

8. The process for forming a non-pneumatic tire of claim 7 wherein the thermoplastic injection process further comprises:
placing the annular beam in the mold, the mold comprising a first portion A that contacts the outer radial extent of the annular beam and a second portion B that contacts an axial extent of the annular beam, the second portion B being extendable in an axial direction,
extending second portion B axially, contacting the axial extent of the beam, forming a mold cavity for which the outer radial extent is defined by the inner radial extent of the annular beam;
injecting a second elastomer that is a thermoplastic elastomer into said cavity, forming the annular support;
deforming the axial extent of the annular beam by the molding pressure, said deformation creating a contact pressure between the annular beam and mold portion B, the contact pressure being sufficient to inhibit flow of the thermoplastic elastomer between the annular beam and the mold and whereby the annular support is formed and affixed to the inner radial extent of the annular beam;
opening the mold, the opening comprising axial retraction of mold portion B;

9. A process for forming an non-pneumatic tire, the process comprising
forming an annular beam, the annular beam comprising a first elastomer, the annular beam further comprising a reinforcement extended in a circumferential direction; the annular beam being free of the circumferential reinforcement at an axial extent over a width of at least 8 mm, the axial extent comprising said elastomer;
molding an annular support affixed to an inner radial extent of the annular beam by a thermoplastic injection process that uses a mold, the thermoplastic injection process comprising:
placing the annular beam in the mold, the mold comprising a first portion A that contacts an outer radial extent of the annular beam and a second portion B that contacts an axial extent of the annular beam, the second portion B being extendable in an axial direction,
extending second portion B axially, contacting the axial extent of the beam, forming a mold cavity for which the outer radial extent is defined by the inner radial extent of the annular beam;
injecting a second elastomer that is a thermoplastic elastomer into said cavity, forming the annular support;
deforming the axial extent of the annular beam by the molding pressure, said deformation creating a contact pressure between the annular beam and mold portion B, the contact pressure being sufficient to inhibit flow of the thermoplastic elastomer between the annular beam and the mold and whereby the annular support is formed and affixed to the inner radial extent of the annular beam;
opening the mold, the opening comprising axial retraction of mold portion B;
removing the NPT from the mold.
